(19) United States
(12) Patent Application Publication
(10) Pub. No.: US 2026/0337415 A1
(43) Pub. Date: Oct. 29, 2026

(54) TWO-PART EPOXY COATING COMPOSITION

(71) Applicant: Henkel AG & Co. KGaA, Duesseldorf (DE)

(72) Inventors: Leo Bin Li, Shanghai (CN); Henry Hongyu Chu, Shanghai (CN); Chunfu Chen, Yokohama (JP); Daoqiang Lu, Shanghai (CN)

(21) Appl. No.: 19/699,462

(22) Filed: Jun. 5, 2026

Related U.S. Application Data
(63) Continuation of application No. PCT/CN2023/137049, filed on Dec. 7, 2023.

(51) Int. Cl. C09D 4/06; C09D 7/65; C09D 163/00

(52) U.S. Cl. CPC C09D 4/06; C09D 7/65; C09D 163/00

(57) ABSTRACT

The present invention relates to a two-part epoxy coating composition, comprising a first part and a second part, the first part comprising: i) an epoxy resin, and ii) a mon-functional or di-functional (meth)acrylate monomer; the second part comprising: iii) an amine curing agent, iv) a mercaptan-terminated polysulfide, and v) a tertiary amine catalyst. The present invention also relates to a cured product of the two-part epoxy coating composition, and the use of the cured product as a coating on substrates.

### TECHNICAL FIELD

The present invention relates to a two-part epoxy coating composition, comprising a first part and a second part, the first part comprising: i) an epoxy resin, and ii) a mon-functional or di-functional (meth)acrylate monomer, the second part comprising: iii) an amine curing agent, iv) a mercaptan terminated polysulfide, and v) a tertiary amine catalyst. The present invention also relates to a cured product of the two-part epoxy coating composition, and the use of the cured product as a coating on substrates.

### BACKGROUND

Two-part epoxy based coating is widely applied on various substrates as a protective coating due to its good adhesion to substrates, excellent chemical resistance wearing resistance, impact resistance, and wide temperature compatibility. For example, a two-part epoxy coating can be applied on outer metallic surface of a pipe or tank in petrochemical plant, steel plant and power plant, to give chemical resistance and wearing resistance, thus protecting the metallic surface from corrosion of rain, chemicals. Also, two-part epoxy coating can be applied on chutes surface to avoid impact of ore.

However, traditional two-part epoxy based coating system comprising epoxy resin part and amine hardener part has the drawbacks of rigid cured product, poor UV resistance, high viscosity and difficulty to be applied on large area using spraying method.

Conventional chemical resistant paints are also commonly applied on the outer metallic surface of a pipe or tank to form a protective coating, and when using conventional paints, however, a primer coating must be applied on the outer metallic surface as the first step to provide an intermediate layer that forms a strong bond with the metallic surface, and provide an outer surface to which topcoats can bond. It is known that the traditional two-part epoxy based coating can be used as primers for paints. In addition, traditional paints are normally solvent based and may cause environmental problem upon application.

Therefore, there is a need for developing a two-part epoxy coating composition, which has low viscosity, good flowability and good flexibility while exhibiting good chemical resistance and adhesion to substrates, and can form a protective coating on substrates by one-time application without need of a primer coat or topcoat, and avoid the use of solvent.

### SUMMARY

In one aspect of the present invention, there is provided a two-part epoxy coating composition, comprising:
a first part comprising:
   i) an epoxy resin, preferably an aromatic difunctional epoxy resin, and
   ii) a mono-functional or di-functional (meth)acrylate monomer,
and
a second part comprising:
   iii) an amine curing agent,
   iv) a mercaptan-terminated polysulfide, and
   v) a tertiary amine catalyst.

In another aspect of the present invention, there is provided a cured product obtained from the two-part epoxy coating composition according to the invention.

In a further aspect of the present invention, there is provided the use of the cured product according to the invention as a coating on various substrates.

The two-part epoxy coating composition according to the invention has low viscosity and good flowability and has good flexibility sufficient to withstand the low or high temperature to which the substrates may be exposed, while exhibiting excellent chemical resistance and good adhesion to various substrates. Moreover, the coating composition can be applied on the substrates at one time to form a coating which functions to effectively protect the substrates from chemical corrosion, without need of a primer coat or a top coat.

### DETAILED DESCRIPTION

It is to be understood by one of ordinary skill in the art that the present disclosure is a description of exemplary embodiments only and is not intended as limiting the broader aspects of the present invention. Each aspect so described may be combined with any other aspect(s) unless clearly indicated to the contrary. Any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, all wt % or % by weight values quoted herein are percentages by weight.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “consisting of” as used herein is close-ended and excludes additional, intentionally added members, elements or process steps.

The term “at least one” or “one or more” used herein to define a component refers to the type of the component, and not to the absolute number of molecules.

The terms “about”, “around” and the like used herein in connection with a numerical value refer to the numerical value ±10%, preferably ±5%. All numerical values herein should be interpreted as being modified by the term “about”.

Unless specified otherwise, the recitation of numerical end points includes all numbers and fractions subsumed within the respective ranges, as well as the recited end points.

Unless otherwise defined, all terms used in the present invention, including technical and scientific terms, have the meaning as commonly understood by one of the ordinary skilled in the art to which this invention belongs.

The epoxide equivalent weight (EEW) mentioned herein is determined according to ASTM D1652.

Hereinafter the two-part epoxy coating composition will be described in detail.

The two-part epoxy coating composition according to the invention comprises
a first part comprising:
   i) an epoxy resin, preferably an aromatic difunctional epoxy resin, and
   ii) a mono-functional or di-functional (meth)acrylate monomer,
and
a second part comprising:
   iii) an amine curing agent,
   iv) a mercaptan-terminated polysulfide, and
   v) a tertiary amine catalyst.

### The First Part

The term “first part” used herein does not intend to define the order of this part, but is used merely to name the part so as to be distinguished from other parts, such as the second part. In other words, the first part and the second part do not mean that they are provided in such an order, on the contrary, they can be provided in any order. Likewise, the term “second part” also does not intend to define the order of this part but to name the part so as to be distinguished from the first part. Alternatively, the first part may be called as “epoxy part” and the second part may be called as “curing agent part”.

The first part comprises: i) an epoxy resin, and ii) a (meth)acrylate monomer.

### Epoxy Resin:

The first part of the present invention comprises at least one epoxy resin. The epoxy resin may be any common epoxy resin containing at least two epoxy groups per molecule. The epoxy resin may be aliphatic, cycloaliphatic, or aromatic.

Suitable epoxy resin includes glycidyl ethers of polyhydric alcohols and polyhydric phenols; glycidyl esters of polycarboxylic acids.

In certain embodiments, the epoxy resin is selected from the group consisting of aliphatic epoxy resin; cycloaliphatic epoxy resin, epoxy novolac resin bisphenol-A epoxy resin, bisphenol-F epoxy resin, hydrogenated bisphenol-A-epoxy resin, hydrogenated bisphenol-F-epoxy resin, propylene glycol epoxy resin; reaction products of polyetherpolyol with epichlorohydrin, polycarbonatediol based glycidyl ethers, and, epoxy silicone copolymers.

In a preferred embodiment, the epoxy resin is an aromatic difunctional epoxy resin. The aromatic difunctional resin refers to an epoxy resin containing two epoxy groups and containing at least one aromatic unit in the molecule (for example, in the backbone or in a side chain, if present, or in both backbone and side chain). Suitable aromatic difunctional epoxy resins used herein include aromatic glycidyl ethers for example, those that may be prepared by reacting a dihydric phenol (i.e. a phenol with another functional group having a reactive proton such as for example a hydroxyl group) with an excess of epichlorohydrin. Examples of useful dihydric phenols include resorcinol, catechol, hydroquinone, and bisphenols.

Preferably, the aromatic difunctional epoxy resins used herein, independently from each other, are selected from bisphenol A epoxy resins (which are derived from bisphenol A and epichlorohydrin or are reaction products of bisphenol A and epichlorohydrin); bisphenol F epoxy resins (which are derived from bisphenol F and epichlorohydrin or are reaction products of bisphenol F and epichlorohydrin), bisphenol S epoxy resins (which are derived from bisphenol S and epichlorohydrin or are reaction products of bisphenol S and epichlorohydrin), phenol novolac epoxy resins (which are derived by reacting phenol with formaldehyde and then reacting with epichlorohydrin); cresol novolac epoxy resins (which are derived by reacting cresol with formaldehyde and then reacting with epichlorohydrin); tetrabromobisphenol A epoxy resins; tetrabromobisphenol F epoxy resins; and combinations thereof.

Suitable commercially available aromatic difunctional epoxy resins include diglycidyl ether of bisphenol A or of bisphenol F, for example, available under the tradenames “EPON 828”, “EPON 862” from Hexion Specialty Chemicals, “DER-331,” “DER-332,” and “DER-334” from Dow Chemical; E51 and E44.

The epoxy resin may have a suitable epoxide equivalent weight, which can be determined by a skilled person in the art according to practical experience. In certain embodiments, the epoxy resin has an epoxide equivalent weight of less than 400 g/eq, preferably from 100 to 300 g/eq, such as from 110 to 250 g/eq. As understood by a person skilled in the art, if the epoxy equivalent weight is too large, which means that the molecular weight of the epoxy resin is large, the resin is in a state of semi-solid or solid and will not be suitable for use in the composition. If the epoxy equivalent weight is too small, the epoxy resin usually functions as a diluent and will not have a sufficient strength to be used as the main resin in the composition.

The epoxy resin is contained in the first part in an amount of 40 wt % to 80 wt. %, preferably 50 wt. % to 70 wt. %, such as 60 wt %, 62 wt. %, 64 wt %, based on the total weight of the first part.

### (Meth)acrylate Monomer:

The first part according to the present invention further comprises a mono-functional or difunctional (meth)acrylate monomer. The (meth)acrylate monomer refers to an acrylate monomer and/or a methacrylate monomer. Suitable examples of mono-functional (meth)acrylate include isobornyl acrylate (IBOA), 2-hydroxyethyl methacrylate (HEMA), tetrahydrofurfuryl methacrylate (THFMA), lauryl acrylate (LA) etc. Suitable examples of difunctional (meth)acrylate include 1,6-hexanediol diacrylate, polyethylene glycol diacrylate, for example, PEG400DA, PEG600DA etc.

Suitable commercially available (meth)acrylate monomer includes Visiomer® products from Evonik such as Visiomer HEMA, Visiomer IBOA; Sartomer SR 335 (LA) from Sartomer; and Laromer HDDA from BASF etc.

Preferably, the (meth)acrylate monomer is contained in the first part in an amount of 1 wt. % to 10 wt. %, such as 2 wt. %, 3 wt %, 4 wt %, 5 wt %, 6 wt. %, based on the total weight of the first part.

Without wishing to be bound by theories, it is believed that using the combination of the above-mentioned epoxy resin, especially aromatic difunctional epoxy resins and the mono-functional or difunctional (meth)acrylate monomer is helpful for achieving the beneficial technical effect of the present invention. In particular, the epoxy resin is used to provide basic mechanical strength and adhesion strength of the composition according to the invention. The mono-functional or difunctional (meth)acrylate monomer is used to reduce viscosity, improve wetting to substrates, improve flexibility and chemical resistance of the composition according to the invention.

### The Second Part

The second part according to the present invention comprises, as essential components, an amine curing agent, a mercaptan-terminated polysulfide and a tertiary amine catalyst.

### Amine Curing Agent:

The second part comprises an amine curing agent. Various amines conventionally used in the art as a curing agent can be used for this purpose, including aliphatic amine, alicyclic amine, aromatic amines, and cycloaliphatic amines. A person skilled in the art would recognize that as a curing agent, the amines used herein contain reactive hydrogen. Suitable amines may comprise primary or secondary diamines or polyamines. Examples of suitable amine curing agent include 1.2-ethylene diamine, 1,2-propylene diamine, 1.8-p-methane diamine, isophorone diamine, propane-2.2-cyclohexyl amine, and methane-bis-(4-cyclohexylamine), 4,4′-methylenedicyclohexanamine, phenylene diamines and toluene diamines, for example o-phenylene diamine and p-tolylene diamine, 2,4- or 2,6-diaminotoluene and 2,4′- or 4,4′-diaminodiphenyl methane.

In a preferred embodiment, the amine curing agent is a non-aromatic amine curing agent, which may be selected from isophorone diamine, 4,4′-methylenedicyclohexanamine.

Commercially available examples of the amine curing agent include Wanamine HMDA, Wanamine IPDA from Wanhua.

Preferably, the amine curing agent is contained in the second part in an amount of from 10 to 50 wt %, preferably from 20 to 40 wt %, such as 30 wt %, 35 wt. %, 40 wt %, based on the total weight of the second part.

### Mercaptan-terminated Polysulfide:

The second part also comprises a mercaptan-terminated polysulfide. The mercaptan-terminated polysulfides are characterized by the fact that they have recurring polysulfide linkage between organic radicals having at least two primary carbon atoms which are connected to disulfide linkages. Typical examples of the polysulfide polymers are those corresponding to the general formula:

HS—(—RSS—)ₙ—RSH
wherein each R is independently an organic polyvalent radical, preferably divalent alkylene oxahydrocarbon radicals, n is 5-20.

In a preferred embodiment, the mercaptan-terminated polysulfide suitable for use in the present invention has the following formula:

HS(C₂H₄—O—CH₂—O—C₂H₄—SS)ₙ—C₂H₄—O—CH₂—O—C₂H₄—SH

Preferably, molecular weight of the polysulfide is from 1000-4000.

Commercially available examples of the polysulfide which is suitable for use in the present invention include THIOKOL LP 3 from Toray, Thioplast G4 from Nouryon.

The mercaptan-terminated polysulfide serves as a modifier for the epoxy resin as described above to improve the flexibility of the epoxy coating composition according to the invention.

Preferably, the polysulfide is contained in the second part in an amount of from 10 to 50 wt %, preferably, from 20 to 40 wt %, such as 30 wt %, 35 wt %, 40 wt. %, based on the total weight of the second part.

### Tertiary Amine Catalyst:

The second part also comprises a tertiary amine as a catalyst to facilitate the reaction of the epoxy resin with the mercaptan-terminated polysulfides when the first part and the second part are mixed upon application. Preferably, suitable examples of the tertiary amine include 2,4,6-tris(dimethylaminomethyl)phenol, N-aminoethylpiperazine, N,N-dimethyl-1-phenylmethanamine, 1,8-diazabicyclo[5.4.0]undec-7-ene etc.

Commercially available examples of the tertiary amine include Ancamine K 54, Ancamine AEP, DABCO BDMA, Amicure DBU from Evonik.

Preferably, the tertiary amine catalyst is contained in the second part in an amount from 0.5 to 10 wt %, preferably from 1 to 5 wt %, such as 1 wt. %, 2 wt. %, 3 wt. % based on the total weight of the second part.

### Other Additives

The coating composition according to the present invention may comprise one or more additives that are conventionally used in the art, such as, a filler, a reactive diluent, a UV stabilizer, a defoamer, an adhesion promoter, a colorant, rheology modifier, a levelling agent, a coupling agent, a surfactant, a catalyst. The additives can perform several functions, such as modifying the rheology of the coating in a desirable way, promoting adhesion to the substrate, reducing overall cost per unit weight, absorbing moisture or oils from the coating composition or from a substrate to which it is applied.

The additive may be contained in either or both of the first part and the second part, as long as the additive does not react with the ingredient(s) in the first part and/or the second part where it is contained.

Fillers may optionally be added to the first part and/or the second part according to the present invention, to, for example, promote adhesion, improve corrosion resistance, control the rheological properties of the coating composition, and/or reduce shrinkage during curing.

Suitable fillers include, but are not limited to, calcium carbonate, talc, carbon black, barium sulfate, titanium dioxide.

Examples of commercially available fillers include those sold under tradenames Carbosil®, such as Cabosil TS 720, Carbosil M5 from Cabot Corporation, BYK 410 from BYK-Chemie GmbH, Tale DH 600B from Yingkou Dahai talc mining Ltd.

Further customary additives for the epoxy coating composition are reactive diluents, for example Heloxy modifier 68 (Neopentyl Glycol Diglycidyl Ether) from Momentive, UV stabilizers, for example Tinuvin 765 from BASF; colorants, for example carbon black and titanium oxide, coupling agents, for example Silquest A 187 from Momentive.

Further additives which may be mentioned are: adhesion promoters, for example silquest A 187 from Momentive, rheology modifiers, for example BYK 410 from BYK corporation, levelling agents, for example BYK 320 from BYK corporation.

The additives may be contained in the coating composition of the present invention in an amount of from 10 wt % to 50 wt %, preferably from 20 wt % to 40 wt % such as 25 wt %, 30 wt %, 35 wt %, 40 wt. %, based on the total weight of the coating composition.

In a preferred embodiment, the epoxy coating composition according to the invention is free of any solvent or reactive diluent.

### Preparation of the Coating Composition

The first part is prepared by mixing all ingredients in the first part together. The second part is prepared by mixing all ingredients in the second part together. The first part and the second part are stored separately before use.

The two-part epoxy coating composition of the present invention is prepared by mixing the first part and the second part shortly before use. The mixing can be done manually, or by conventional mixing apparatuses, so as to form a uniform curable composition.

The first part and the second part can be mixed in a weight ratio of from 10:1 to 1:5, such as from 5:1 to 1:3, or from 3:1 to 1:1, especially 2:1 or 1:1.

The epoxy coating composition according to the invention preferably has a viscosity of from 3000 to 6000 mPa·s, measured according to ASTM D1084, so that the coating composition can be readily applied by spraying on the substrates.

### Application of the Coating Composition

The two-part epoxy coating composition according to the invention can be applied to any suitable substrate by means of conventional methods in the art. For example, it can be applied by brush coating, roller coating, or spraying methods.

Prior to application of the coating composition, the substrate to be coated may be preferably cleaned or pre-treated to remove foreign matter therefrom, to facilitate the adhesion of the coating composition thereto. For example, a rusted metal substrate can be pre-treated to the level of ST2, ST3, SA2.5 etc, and the coating composition shows good adhesion to all the above-mentioned substrate surface conditions.

After application, the coating composition is typically cured at a temperature of from about 20 °C to about 80 °C or from about 25 °C to about 60 °C, to obtain a cured product which is suitable as a coating on the substrates.

The present invention, therefore, also relates to a cured product obtained from the two-part epoxy coating composition according to the invention. Moreover, the present invention relates to use of the cured product as a coating on the substrates.

The cured product as a coating exhibits excellent flexibility and chemical resistance, which is desirable for protection of various substrates. Particularly suitable substrates are metal substrates, such as steels, stainless steels, carbon steels, iron, copper, aluminum, zinc, or alloys thereof.

The coating may have a thickness of from 200 to 400 μm, preferably from 150 to 350 μm. The thickness of the coating that is suitable depends on the substrates to be coated and can be determined in individual cases by a skilled person in the art.

The two-part epoxy coating composition according to the invention is particularly suitable as a coating for pipes and tanks in petrochemical plant, steel plant, power plant, etc. The coating serves to protect outer surfaces of the pipes and tanks from corrosion of rain or chemicals.

### EXAMPLE

The invention will now be described by way of the following examples. The following examples are intended to assist one skilled in the art to better understand and practice the present invention. The scope of the invention is not limited by the examples but is defined in the appended claims. All parts and percentages are based on weight unless otherwise stated.

Materials used in the examples:

| | |
|---|---|
| YN 1828 | Liquid difunctional epoxy resin, derived from bisphenol |
| | Aa nd epichlorohydrin, having an EEW of |
| | 185-192 g/eq, available from Yangnong. |
| Visiomer HEMA | Acrylate monomer from Evonik |
| BYK 410 | Thixotropic additive from BYK |
| BYK 320 | Flowability additive from BYK |
| BYK 530 | Defoamer additive from BYK |
| Thiokol LP 3 | Polysulfide from Toray |
| THIOPLAST G4 | Polysulfide from Nouryon |
| Ancamine K 54 | Tertiary amine catalyst from Evonik |
| Ancamine 2280 | Modified amine from Evonik |
| Ancamine 1618 | Modified amine from Evonik |
| Ancamine AEP | Tertiary amine catalyst from Evonik |
| DH-600B | Talc powder, available from Yingkou Dahai Talc |
| | Mining Ltd , China |
| 1250 mesh | Barium Sulphate from Shanghai Yuejiang corporation. |
| Barium Sulphate | |
| Tinuvin 765 | UV stabilizer from BASF |
| SR 9000 | Titanium dioxide from Shandong Dongjia corporation |
| Regal 300 R | Carbon black from Cabot corporation |

### Test Methods:

### Viscosity Test

Viscosity was tested according to ASTM D1084 entitled, “Viscosity of Adhesives”, and the test procedures were prepared according to ASTM D1084. Rotation speed is set according to viscosity of the material.

### Flowability Test

Flowability is evaluated by roller coating on vertical surfaces to check sag resistance and levelling property of the coating in curing process.

### Spraying Property Test

Spraying property is evaluated by single component airless spraying machine. Spraying property is most correlated with viscosity and thixotropic property of the coating. Spraying property is evaluated by single component airless spraying machine, also sag resistance and levelling property is also checked after spraying.

### Adhesion Strength Test

Adhesion strength is evaluated according to ASTM 4541-17, entitled “Standard Test Method for Pull-Off Strength of Coatings Using Portable Adhesion Testers” Firstly, a substrate is pretreated according to ISO 8501-1 entitled “Preparation of steel substrates before application of paints and related products” to meet ST 2 requirement. Then, a coating is applied on the substrate surface to make sure coating is fully cured. Then adhesion strength is tested according to ASTM 4541-17.

In the test, rusted steel is used as the substrate, and the thickness of the coating is about 200 μm.

### Flexibility Test

The coating material is applied on a tinplate with a thickness of 200-250 μm. After curing for 7 days at room temperature, the coated tinplate is bended to 90 degree to check whether crack is happened on the bending area.

### Chemical Resistance Test

Salt fog test is conducted following GB/T 1771 to evaluate salt fog resistance of the coating material. The coating material is applied on a steel plate with a thickness of 200-250 μm and cured at room temperature. The coated steel plate is subjected to the salt fog test and after 1000 hour exposure, a visual inspection is performed to determine whether a sign of rust develops on the coated plate.

### Examples 1-3 and Comparative Examples 1-3

Coating compositions of Examples 1-3 and Comparative Examples 1-3 were prepared as follows with the ingredients listed in the following Tables 1-2, and were tested according to the above-mentioned methods:
First part A was prepared by mixing all the ingredients of the first part A with stirring and then applying vacuum for degassing so as to obtain a degassed mixture, which was then stored in a container.
Second part B was prepared by mixing all the ingredients of the second part B with stirring and then applying vacuum for degassing so as to obtain a degassed mixture which was then stored in another container different from the container of the first part A.
The first part A and the second part B were mixed in a specific ratio as indicated in the Tables 1-2 to obtain a coating composition. The obtained coating composition was applied on a substrate by spraying, and cured at room temperature (around 25 °C) to form a coating. The resulting coating was tested to determine flexibility and chemical resistance according to the above-mentioned methods.

TABLE 1
Examples 1-3

| Components | Ex.1 | Ex.2 | Ex.3 |
|---|---|---|---|
| First Part A | wt. % | wt. % | wt. % |
| YN 1828 | 60.00 | 62.00 | 60.00 |
| HEMA | 4.00 | 2.00 | 5.00 |
| BYK A 530 | 0.20 | 0.20 | 0.40 |
| BYK 410 | 0.50 | 0.50 | 1.00 |
| BYK 320 | 0.20 | 0.20 | |
| DH-600B | | | 5.00 |
| 1250 mesh Barium Sulphate | 14.90 | 14.90 | 28.60 |
| SR 9000 | 20.00 | 20.00 | |
| Regal 300 R | 0.20 | 0.20 | |
| Total | 100.00 | 100.00 | 100.00 |
| Second Part B | wt. % | wt. % | wt. % |
| Thiokol LP 3 | 31.50 | 31.50 | |
| THIOPLAST G4 | | | 40.50 |
| Ancamine 1618 | 30.50 | 30.50 | |
| Ancamine 2280 | | | 16.00 |
| Ancamine K 54 | 1.00 | 1.00 | 1.00 |
| Ancamine AEP | | | 5.50 |
| Tinuvin 765 | 1.00 | 1.00 | 1.00 |
| DH-600B | 10.00 | 10.00 | 5.00 |
| 1250 mesh Barium Sulphate | 26.00 | 26.00 | 30.50 |
| Cabosil TS 720 | | | 0.50 |
| Total | 100.00 | 100.00 | 100.00 |
| First Part A: Second part B | 1:1 | 1:1 | 1:1 |
| (by weight) | | | |
| First part A viscosity | 4763 | 4763 | 4428 |
| CP52 5 rpm/mPa · s | | | |
| First part A viscosity | 3056 | 3453 | 3210 |
| CP52 50 rpm/mPa · s | | | |
| Second part B viscosity | 3175 | 3175 | 7461 |
| CP52 5 rpm/mPa · s | | | |
| Second part B viscosity | 12604 | 2604 | 5620 |
| CP52 50 rpm/mPa · s | | | |
| Flowability/levelling property | Good | Good | good |
| Spraying ability | Can spray | Can spray | Can spray |
| Flexibility (90 degree bending | No crack | No crack | No crack |
| test) | | | |
| Adhesion strength/Mpa, ST 2 | 10.07 | 12.78 | 9.08 |
| Chemical resistance (salt fog | No sign | No sign | No sign |
| test) | of rust | of rust | of rust |

TABLE 2
Comparative Examples 1-3

| Components | CE.1 | CE.2 | CE.3 | CE.4 |
|---|---|---|---|---|
| First Part A | wt. % | wt. % | wt. % | wt. % |
| YN 1828 | 64.00 | 64.00 | 60.00 | 62.00 |
| HEMA | | | 4.00 | 2.00 |
| BYK A 530 | 0.20 | 0.20 | 0.20 | 0.20 |
| BYK 320 | 0.20 | 0.20 | 0.20 | 0.20 |
| BYK 410 | 0.50 | 0.50 | 0.50 | 0.50 |
| DH-600B | | | | |
| 1250 mesh Barium | 14.90 | 14.90 | 14.90 | 14,90 |
| Sulphate | | | | |
| SR 9000 | 20.00 | 20.00 | 20.00 | 20.00 |
| Regal 300 R | 0.20 | 0.20 | 0.20 | 0.20 |
| Total | 100.00 | 100.00 | 100.00 | 100.00 |
| Second Part B | wt. % | wt. % | wt. % | wt. % |
| Thiokol LP 3 | 31.50 | | | |
| Ancamine 1618 | 30.50 | 62.00 | 62.00 | 62.00 |
| Ancamine 2280 | | | | |
| Ancamine K 54 | 1.00 | 1.00 | 1.00 | 1.00 |
| Ancamine AEP | | | | |
| Tinuvin 765 | 1.00 | 1.00 | 1.00 | 1.00 |
| DH-600B | 10.00 | 10.00 | 10.00 | 10.00 |
| 1250 mesh Barium | 26.00 | 26.00 | 26.00 | 26.00 |
| Sulphate | | | | |
| Total | 100.00 | 100.00 | 100.00 | 100.00 |
| First Part A:Second | 1:1 | 1:1 | 1:1 | 1:1 |
| Part B (by weight) | | | | |
| First part A viscosity | 25000 | 25000 | 4763 | 4763 |
| CP52 5 rpm/mPa · s | | | | |
| First part A | 23650 | 23650 | 3056 | 3453 |
| viscosity/mPa · s | | | | |
| CP52 50 rpm/mPa · s | | | | |
| Second part B | 3175 | 2858 | 2858 | 2858 |
| viscosity/mPa · s | | | | |
| CP52 5 rpm/mPa · s | | | | |
| Second part B | 2604 | 2461 | 2461 | 2461 |
| viscosity/mPa · s | | | | |
| CP52 50 rpm/mPa · s | | | | |
| Flowability/leveling | Poor | Poor | Good | Good |
| property | | | | |
| Spraying ability | cannot | cannot | Can spray | Can |
| | spray | spray | | spray |
| Flexibility (90 degree | No crack | Crack | No crack | No |
| bending test) | | | | crack |
| Adhesion strength/ | 11.71 | 4.19 | 9.17 | 8.49 |
| Mpa, ST 2 | | | | |
| Chemical resistance | rust | rust | rust | rust |
| (salt fog test) | appears | appears | appears | appears |

The test results as shown in the above tables 1 and 2 illustrate that the coating composition according to the invention exhibits low viscosity, good flowability and spraying ability, and the cured coating shows good adhesion to the substrate and excellent flexibility and chemical resistance. Compared to the conventional two-part epoxy coating composition of Comparative Examples 1-3, the combination of (meth)acrylate monomer and polysulide in the coating composition of Examples 1-3 according to the present invention significantly reduces the viscosity of the composition, and improves the spraying ability, flexibility, adhesion strength and chemical resistance properties.

What is claimed is:

1. A two-part epoxy coating composition comprising:
a first part comprising:
i) an epoxy resin, and
ii) a m ono-functional or di-functional (meth)acrylate monomer,
and
a second part comprising:
iii) an amine curing agent,
iv) a mercaptan-terminated polysulfide, and
v) a tertiary amine catalyst.

2. The composition according to claim 1, wherein the epoxy resin is at least one aromatic difunctional epoxy resin.

3. The composition according to claim 2, wherein the aromatic difunctional epoxy resin is selected from bisphenol A epoxy resins; bisphenol F epoxy resins, bisphenol S epoxy resins; phenol novolac epoxy resins; cresol novolac epoxy resins, tetrabromobisphenol A epoxy resins, tetrabromobisphenol F epoxy resins, and combinations thereof.

4. The composition according to claim 1, wherein the mono-functional (meth)acrylate monomer is selected from isobornyl acrylate, 2-hydroxyethyl methacrylate, tetrahydrofurfuryl methacrylate, lauryl acrylate, and combinations thereof, and the di-functional (meth)acrylate monomer is selected from 1,6-hexanediol diacrylate polyethyleneglycol diacrylate, and combinations thereof.

5. The composition according to claim 1, wherein the epoxy resin is contained in the first part in an amount of 40 wt % to 80 wt. % based on the total weight of the first part.

6. The composition according to claim 1, wherein the (meth)acrylate monomer is contained in the first part in an amount of 1 wt. % to 10 wt. %, based on the total weight of the first part.

7. The composition according to claim 1, wherein the epoxy resin has an epoxide equivalent weight of less than 400 g/eq.

8. The composition according to claim 1, wherein the tertiary amine catalyst is selected from 2,4,6-tris(dimethylaminomethyl)phenol, N-aminoethylpiperazine, N,N-dimethyl-1-phenylmethanamine, 1,8-diazabicyclo[5.4.0]undec-7-ene, and combinations thereof.

9. The composition according to claim 1, wherein the amine curing agent is contained in the second part in an amount of from 10 to 50 wt % based on the total weight of the second part.

10. The composition according to claim 1, wherein the mercaptan-terminated polysulfide is contained in the second part in an amount of from 10 to 50 wt % based on the total weight of the second part.

11. The composition according to claim 1, wherein the tertiary amine catalyst is contained in the second part in an amount from 0.5 to 10 wt % based on the total weight of the second part.

12. The composition according to claim 1, wherein the weight ratio of the first part and the second part in the composition is from 10:1 to 1:5.

13. A cured product of the two-part epoxy coating composition according to claim 1.
